(19) United States
(12) Patent Application Publication
(10) Pub. No.: US 2022/0144157 A1
(43) Pub. Date: May 12, 2022

(54) MOBILE BUSINESS UNIT HAVING REMOVABLE WHEELS, AUTOMATIC LIFT AND LEVELING SYSTEM, AND REMOVABLE OR RETRACTABLE HITCH & COMPOSITE IMPERMEABLE FLOORING STRUCTURE HAVING INTEGRATED BASEBOARDS

(71) Applicant: REEF GLOBAL IP LLC, Miami, FL (US)

(72) Inventor: Kevin W. Haynes, Parkland, FL (US)

(21) Appl. No.: 17/519,803

(22) Filed: Nov. 5, 2021

Related U.S. Application Data
(60) Provisional application No. 63/110,675, filed on Nov. 6, 2020.
(60) Provisional application No. 63/123,004, filed on Dec. 9, 2020.

(51) Int. Cl. B60P 3/025; B62D 21/02; B60D 1/54; B62D 25/20; B62D 27/02

(52) U.S. Cl. CPC B60P 3/0257; B62D 21/02; B62D 27/02; B62D 25/20; B60D 1/54

(57) ABSTRACT

Mobile business units can provide business units for a variety of businesses including, for example, a mobile kitchen or “ghost kitchen”, a mobile insurance or disaster relief office, and a mobile medical facility. Novel impermeable surface configurations enabling sterilization of the interior of the mobile business units are provided. Novel deployment of the mobile business unit can include removal of an axle frame, tires, and axles to convert the mobile business unit to a stationary business unit. A removable hitch assembly can shorten the length of the mobile business unit. Cloud software can integrate the business unit with delivery drivers to lower the cost of “last mile delivery” to end customers.

### CROSS REFERENCE TO RELATED APPLICATIONS

The present application claims the benefit of U.S. Provisional Patent Application No. 63/110,675 filed Nov. 6, 2020 and U.S. Provisional Patent Application 63/123,004 filed Dec. 9, 2020, the disclosure of which is incorporated by reference herein in its entirety

### TECHNICAL FIELD

This invention relates to a mobile business unit and more particularly to a mobile business unit having a removable axle assembly and a composite impermeable flooring structure with integrated baseboards.

### BACKGROUND ART

To accommodate the increased demand for takeout and delivery, more restaurants are depending on various types of remote off-premises kitchens, or “ghost kitchens”. Ghost kitchens allow restaurants to outsource the making of their takeout and delivery meals, while enabling the preparation of the meals closer to the customer.

The closer proximity to the customer lessens the expense of the “last mile delivery”, which is the flow of goods from the nearest transport hub to their final destination. While home delivery has increased, many business owners have become keenly aware of the last mile delivery expense. Last mile logistics can make up a large portion of product cost, particularly when meals or perishable goods are being delivered. Ghost kitchens can expand a restaurant's footprint and brand recognition beyond the restaurant's immediate neighborhood. Ghost kitchens can also provide meals without cannibalizing the stoves, walk-ins and prep areas needed to serve seated diners indoors or out. Newly started restaurants can test the business viability of geographic locations without the rent expense of brick and mortar kitchens, simply by parking a ghost kitchen in a specific location and testing the demand there.

While many restaurants have transitioned to ghost kitchens, other businesses have taken notice. For example, mobile health care and testing, mobile optometry fabrication, mobile pharmacy, mobile insurance and disaster relief, mobile broadcasting, and mobile offices have changed supply strategy by looking to reduce rent expense while enabling the ability to nimbly move from one community to another. What is needed are new technologies that can meet last mile delivery while providing configurable business units with flexibility to adapt and mobilize.

### SUMMARY OF THE EMBODIMENTS

It is an object of the invention to provide mobile business units, materials for and methods of making mobile business units, and novel mobility, conversion to stationary business units, and integration of the business units for a variety of applications.

The technology can be further summarized in the following features:

In one aspect, a mobile business unit is provided. The mobile business unit includes a mobile container having a base frame and an axle frame removably affixed to the base frame of the mobile container. The mobile container can be configured, for example, as a kitchen, an office, a medical facility, a classroom or an office space, an insurance or disaster relief facility, a fabrication unit, a pharmacy, a grocery-to-go unit, a broadcasting center, or a combination thereof.

In some embodiments, the axle frame includes a first longitudinal frame member extending substantially in a longitudinal direction of and along a first side of the base frame of the mobile container and a second longitudinal frame member extending substantially in a longitudinal direction of and along a second side of the base frame of the mobile container. The axle frame includes a plurality of cross support frame members interconnected between the first and second longitudinal frame members. The axle frame includes a front axle assembly affixed to the axle frame proximate a front end of the axle frame, the front axle assembly including a first wheel proximate the first longitudinal frame member and second wheel proximate the second longitudinal frame member. The axle frame includes a back axle assembly affixed to the axle frame proximate a back end of the axle frame, the back axle assembly including a third wheel proximate the first longitudinal frame member and fourth wheel proximate the second longitudinal frame member. In some embodiments, a mid-axle assembly is affixed to the axle frame proximate a middle of the axle frame, the mid-axle assembly including a fifth wheel proximate the first longitudinal frame member and sixth wheel proximate the second longitudinal frame member. The axle frame also includes a fixture assembly configured to removably interconnect the axle frame to the base frame of the mobile container.

In some embodiments, the fixture assembly includes electromagnetic fasteners, mechanical fasteners (e.g., nuts and bolts), automated mechanical fasteners, hand releasable fasteners, or a combination thereof.

In some embodiments, the mobile business unit includes a lifting system including a piston mechanism positioned at each corner of the base frame, wherein the piston mechanisms are configured to raise the mobile container to enable the removal of the axle frame and to lower the mobile container after removal of the axle frame.

In some embodiments, the lifting system includes a self-leveling controller configured to adjust the piston mechanisms to level the mobile container to a grade of a location.

In some embodiments, the mobile business unit includes a base frame wherein the base frame includes a hitch frame assembly configured to allow the mobile business unit to be towed. In some embodiments, the hitch frame assembly includes a removable hitch assembly, wherein the removable hitch assembly can be removed from the mobile business unit.

In some embodiments, the mobile business unit includes a hitch frame assembly wherein the hitch frame assembly includes a receiver to engage with a hitch on a tow vehicle to allow the mobile business unit to be towed. In some embodiments, the hitch frame assembly includes a retractable hitch post or tongue, which can be retracted.

In one aspect, a mobile business unit is provided wherein the mobile business unit includes a composite impermeable flooring structure having integrated baseboards. The mobile business unit also includes a main frame. The mobile business unit also includes a container frame mounted along a circumference of the main frame, wherein an interior surface of the main frame and one or more interior surfaces of the container frame define an interior volume of the mobile business unit. The mobile business unit also includes a plurality of composite flooring panels disposed on the interior surface of the main frame to form a composite floor. The composite flooring panels include a foundation layer for contacting the interior surface of the main frame. The composite flooring panels also include a resilient or energy absorbent layer disposed over the foundation layer. The composite flooring panels also include a support layer disposed over the resilient or energy absorbent layer. The mobile business unit also includes at least one composite baseboard extending along the main frame around at least a portion of the circumference of the composite floor. The composite baseboards include a wall layer for contacting the interior surface of the container frame. The composite baseboards also include an interior layer disposed over the wall layer. The mobile business unit also includes an impermeable coating extending over the composite floor and the composite baseboard to form an interior surface of the composite impermeable flooring structure having integrated baseboards.

In some embodiments, each composite panel also includes a paint layer, an adhesive layer, or a combination thereof interposed between the foundation layer and the resilient or energy absorbent layer. In some embodiments, the paint layer, adhesive layer, or combinations thereof include at least one of latex paint, oil paint, epoxy, acrylates, acrylic latex, polyvinyl acetate, or combinations thereof. In some embodiments, the foundation layer of each of the plurality of composite flooring panels is attached to the main frame by at least one of screwing, bolting, or welding.

### BRIEF DESCRIPTION OF THE DRAWINGS

Embodiments of the present disclosure will now be described, by way of example only, with reference to the attached Figures, wherein:

FIG. 1 shows a perspective view of a mobile business unit in accordance with various embodiments.

FIG. 2A shows a perspective view of a mobile container frame, a removable hitch assembly, and a removable axle assembly in accordance with various embodiments.

FIG. 2B shows a side view of a first side of a mobile container frame, a removable hitch assembly, and a removable axle assembly in accordance with various embodiments.

FIG. 2C shows a side view of a second side of a mobile container frame, a removable hitch assembly, and a removable axle assembly in accordance with various embodiments.

FIG. 3A shows a perspective view of a removable axle assembly including an axle frame, axles, and tires on rims in accordance with various embodiments.

FIG. 3B shows a top view of a removable axle assembly including an axle frame, axles, and tires on rims in accordance with various embodiments.

FIG. 4A shows a perspective view of a removable axle assembly with an axle frame and wheels under a mobile business unit before the mobile container has been raised utilizing an auto leveling system in accordance with various embodiments.

FIG. 4B shows a perspective view of a removable axle assembly with an axle frame and wheels under a mobile business unit after the mobile container has been raised utilizing an auto leveling system in accordance with various embodiments.

FIG. 4C shows a perspective view of a removable axle assembly with an axle frame and a fixture assembly under a mobile business unit in accordance with various embodiments.

FIG. 4D shows a bottom view of a removable axle assembly with an axle frame and a fixture assembly under a mobile business unit in accordance with various embodiments.

FIG. 4E shows a bottom view of a removable axle assembly with a released fixture assembly under a mobile business unit in accordance with various embodiments.

FIG. 4F shows a perspective view of a removable axle assembly detached from a base frame of a mobile business unit in accordance with various embodiments.

FIG. 4G shows a perspective view of a removable axle assembly rotated under a mobile business unit in accordance with various embodiments.

FIG. 4H shows a perspective view of a removable axle assembly rolled out from under a mobile business unit in accordance with various embodiments.

FIG. 5A shows a perspective view of a removable hitch assembly including a hitch frame and a hitch connector in accordance with various embodiments.

FIG. 5B shows a perspective view of a tongue jack and pintle towing hitch attached to a hitch connector in accordance with various embodiments.

FIG. 6A shows a perspective view of a retractable hitch assembly in accordance with various embodiments.

FIG. 6B shows a perspective view of a retractable hitch assembly and a tongue receiver in accordance with various embodiments.

FIG. 7A shows a perspective view of a base frame atop the removable axle assembly of FIG. 3A in accordance with various embodiments.

FIG. 7B shows a side view of a base frame atop the removable axle assembly of FIG. 3A in accordance with various embodiments.

FIG. 8A shows a perspective view of a main frame atop the base frame of FIG. 7A and FIG. 7B and a removable axle assembly in accordance with various embodiments.

FIG. 8B shows a side view of a main frame atop the base frame of FIG. 7A and FIG. 7B and a removable axle assembly in accordance with various embodiments.

FIG. 9A shows a perspective view of a removable hitch assembly including a hitch connector and hitch frame, which is attached to a base frame in accordance with various embodiments.

FIG. 9B shows a side view of a removable hitch assembly including a hitch connector and hitch frame, which is attached to a base frame in accordance with various embodiments.

FIG. 10 shows a perspective view of a floor including floor panels on the main frame of FIG. 9A, a floor panel at the front of the main frame of FIG. 9A, and a floor panel partially over the hitch frame of FIG. 9A in accordance with various embodiments.

FIG. 11A shows a rear view of a composite impermeable flooring structure having integrated baseboards in a mobile business unit in accordance with various embodiments.

FIG. 11B shows an interior side perspective of a composite impermeable flooring structure having integrated baseboards in a mobile business unit in accordance with various embodiments

FIG. 11C shows an interior detail view of a transition joint of a composite impermeable flooring structure having integrated baseboards in a mobile business unit in accordance with various embodiments.

FIG. 11D shows an interior top detail view of an integrated baseboard and a transition joint of a composite impermeable flooring structure in accordance with various embodiments.

FIG. 12 shows a cross-sectional view of a composite floor panel in accordance with various embodiments.

FIG. 13 shows a cross-sectional side view of an interior of a first side of the mobile business unit of FIG. 1, configured as a ghost kitchen, in accordance with various embodiments.

FIG. 14 shows a cross-sectional side view of an interior of a second side of the mobile business unit of FIG. 1, configured as a ghost kitchen, in accordance with various embodiments.

### DETAILED DESCRIPTION OF SPECIFIC EMBODIMENTS

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments, as the skilled artisan would recognize, even if not explicitly stated herein.

Descriptions of well-known components and processing techniques may be omitted to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

In accordance with various embodiments, a mobile business unit is provided. The mobile business unit can be deployed to a location by towing to the location. After deployment to the location, the mobile business unit can be changed to a stationary business unit by utilizing a lifting system, which can be automated, and rolling a removable axle assembly with tires out from under the mobile business unit. The stationary business unit can be readily converted back to a mobile configuration when needed. The lifting system can be an automated lift that can include or be a part of an auto leveling system, which can be a pneumatic auto leveling system or an auto-leveling hydraulic leveling system. The location for deployment can be a parking spot, for example, a typical parking spot for one to three cars, depending on the size of the mobile business unit. The location can be, for example, a parking deck, a parking lot, along a roadside, on a beach, in a wooded area, or on a lawn. The auto leveling system can provide auto leveling to adjust to the grade of the specific location.

The preferred embodiment of a mobile business unit is depicted as a mobile kitchen herein, but it should be understood that this is only exemplary and that the concepts described herein are equally applicable to other applications, including but not limited to mobile health care and testing, mobile fabrication, mobile pharmacy, grocery-to-go units, mobile insurance and disaster relief, mobile broadcasting, and mobile offices.

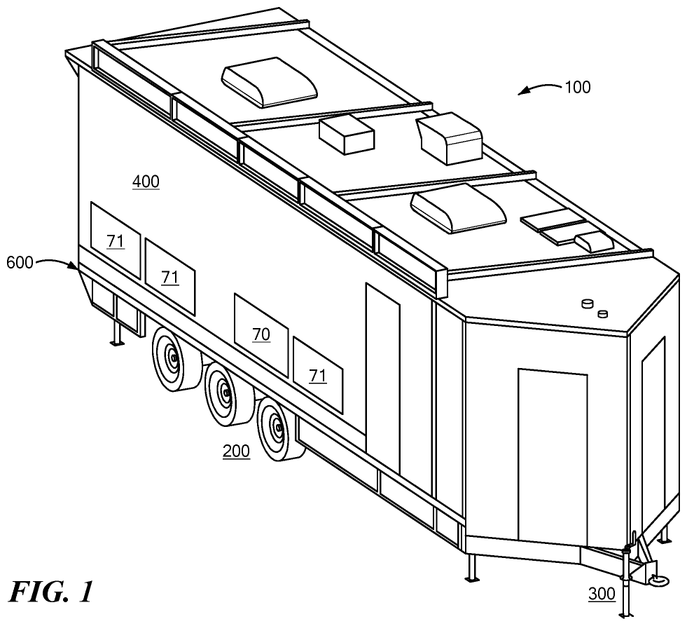

Referring now to FIG. 1, a mobile business unit 100 is provided. The mobile business unit 100 includes a mobile container 400 positioned on top of a trailer assembly 600, which may include a removable axle assembly 200. The removable axle assembly can generally include an axle frame having tires and rims. The mobile business unit can also include a removable hitch assembly 300 including a hitch frame and hitch connector. The mobile container 400 can include a delivery locker driver access door 70 and service access panels 71.

### Removable Axle Assembly

The advantages of a mobile business unit can be enhanced by the capability to provide a stationary business unit. After deploying a mobile business unit, a stationary business unit can further establish a business service or brand in underserved neighborhoods. Conversion to a stationary business unit can provide the advantages of brick and mortar without the lack of mobility. For example, some locations can have zoning restrictions prohibiting mobile units with wheels and hitches, other locations can have restrictions for the outward appearance of a business unit, and the permanence of a superior business location can be enhanced by a stationary business unit. The mobile business unit disclosed herein can quickly provide a stationary business unit. After deployment, the mobile container can be lifted, and the removable axle assembly can be rolled out from underneath. The removable axle assembly can be rapidly removed and re-deployed with a different mobile business unit to a new location if desired.

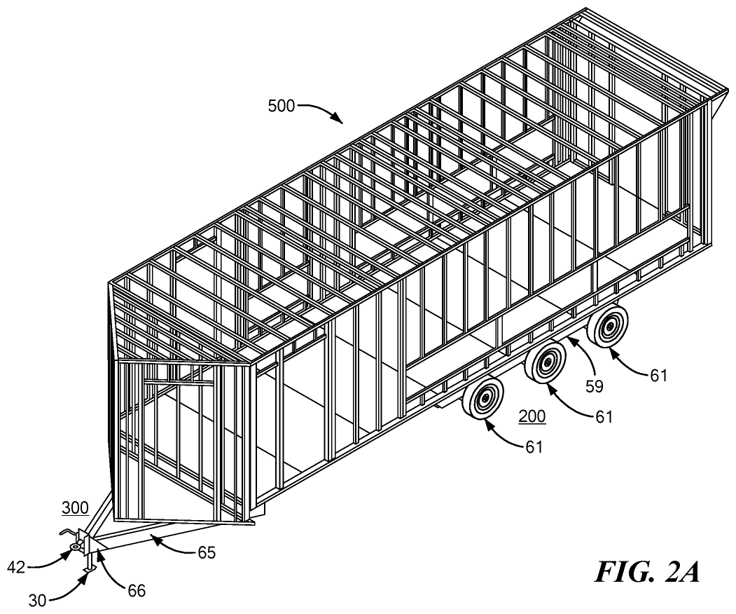

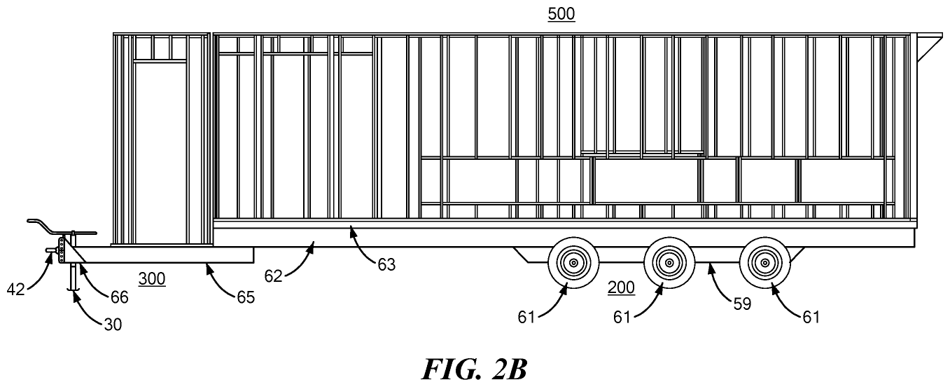

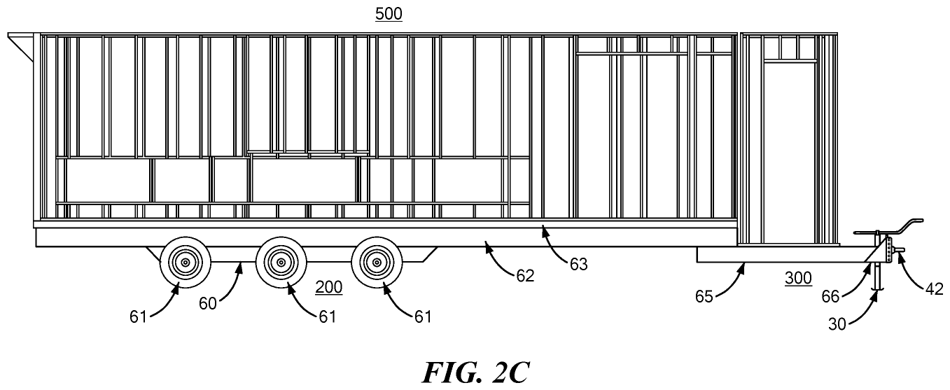

According to some embodiments, the mobile container 400 depicted in FIG. 1 can include a mobile container frame 500, which is depicted in the perspective view of FIG. 2A. Referring to FIG. 2A, the removable axle assembly 200 includes tires and rims 61 and an axle frame with a first longitudinal frame member 59. The side views depicted in FIG. 2B and FIG. 2C show the mobile container frame 500 is affixed to a main frame 63, which is further affixed to a base frame 62. A fixture assembly is configured to removably interconnect the axle frame of the removable axle assembly 200 to the base frame 62. By releasing the fixture assembly, the removable axle assembly 200 can be removed by lifting the mobile unit with the base frame 62 and rolling the removable axle assembly 200 out from underneath. Referring to the removable hitch assembly 300 depicted in FIG. 2B, the hitch frame 65 of the removable hitch assembly 300 can be removed from the base frame 62.

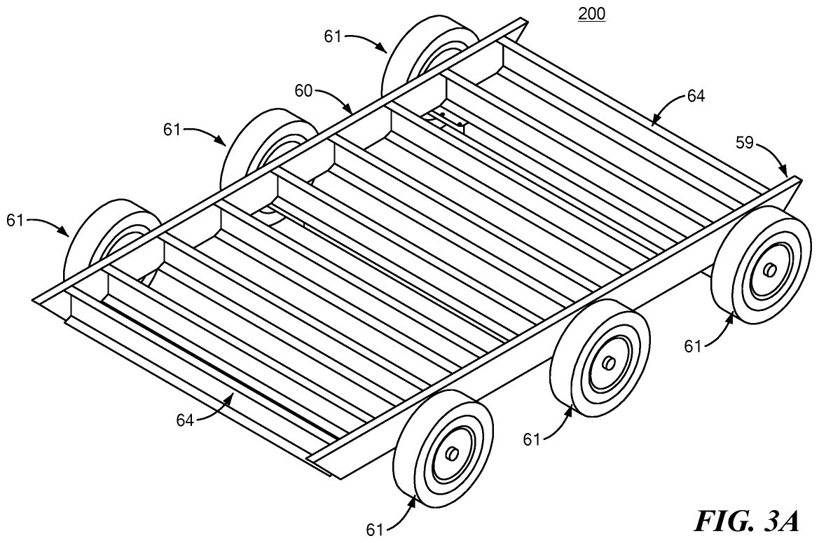

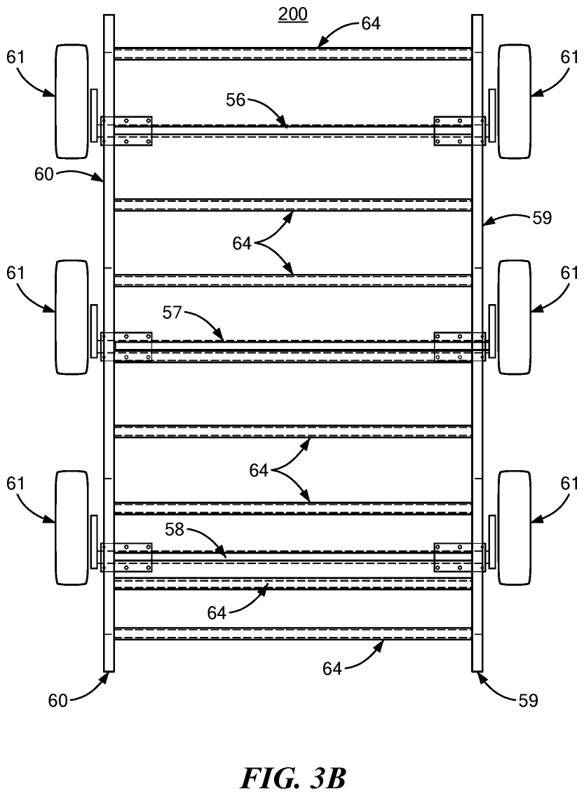

A removable axle assembly 200, in accordance with various embodiments, is depicted in the perspective view of FIG. 3A and in the top view of FIG. 3B. The removable axle assembly 200 has an axle frame with a first longitudinal frame member 59, a second longitudinal frame member 60, and cross support frame members 64. Referring to FIG. 3B, a back axle assembly 56, a mid-axle assembly 57, and a front axle assembly 58 are affixed to the axle frame. The removable axle assembly 200 can include a fixture assembly configured to removably connect to the base frame of the mobile container. The tires with rims 61 can include any size tires and rims that provide a suitable height for the removable axle assembly 200. For example, 12 inch, 13 inch, 14 inch, 15 inch, 16 inch, 17 inch, 18 inch, or 19 inch rims can be utilized with tires of a suitable width. The number of wheel, tires, and axles is not limited, and the example illustrated in FIG. 3A and FIG. 3B can be changed for different configurations. For example, the number of tires, wheels, and axles can be increased for heavier mobile businesses units. As shown, the removable axle assembly includes straight axles, but it will be apparent based on this disclosure that the axles may include shocks and springs. The tires and rims 61 can include steering capabilities integrated with the axles, for example, to aid steering the mobile business unit around corners in tight locations.

The longitudinal frame members can include a first longitudinal frame member 59 extending substantially in a longitudinal direction and a second longitudinal frame member 60 extending substantially in a longitudinal direction of the mobile business unit. Any number of additional longitudinal frame members can be added, for example, to provide more strength or to provide for rugged locations. The cross support frame members 64 can include a plurality of cross support frame members interconnected between the first and second longitudinal frame members. The configuration of the axle frame can be any configuration suitable to affix the tires with rims and to transport the mobile business unit. The frame members can be configured, for example, with additional longitudinal frame members, with cross support frame members intersecting or with a box frame surrounding the axle frame. The cross support frame members 64 and the longitudinal frame members 59 and 60 can each be fabricated, for example, from a lightweight metal, alloy, carbon fiber, or polymer material.

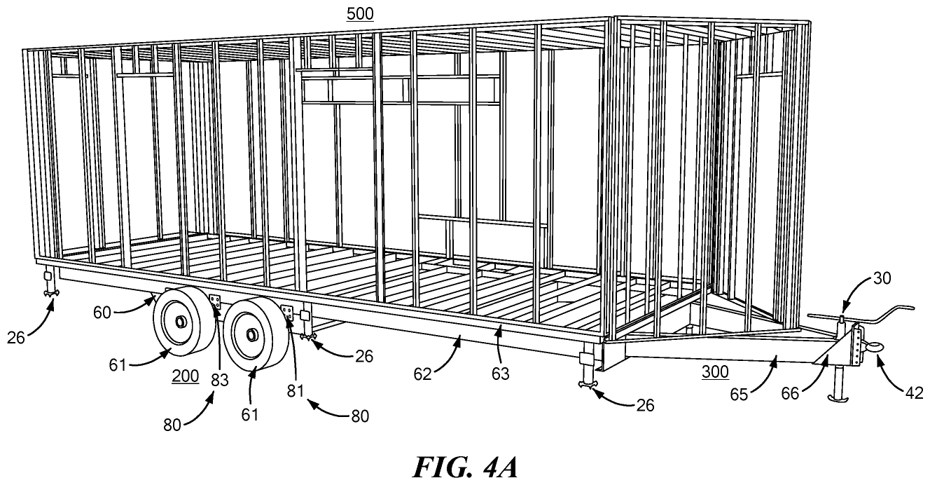

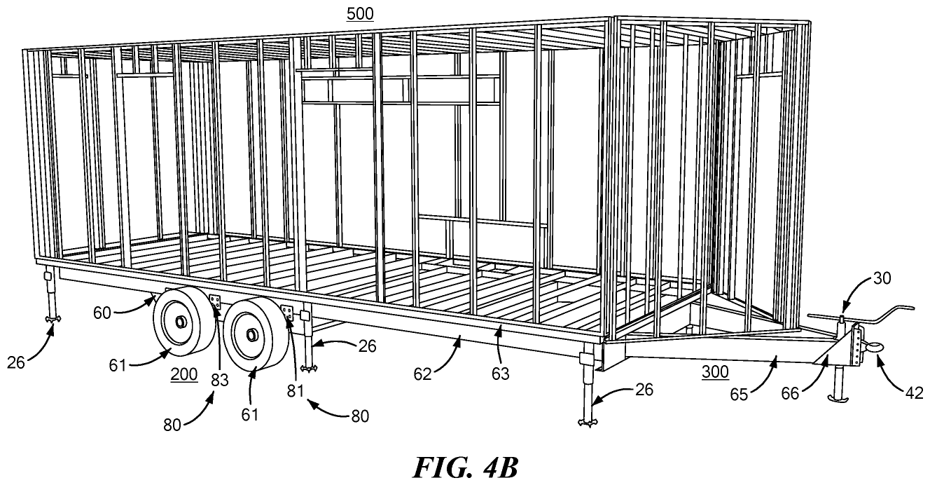

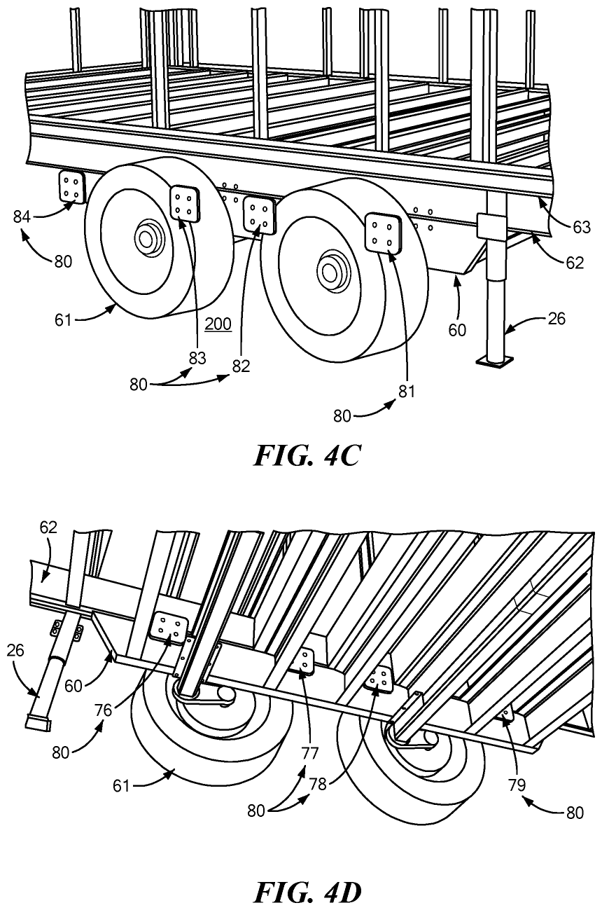

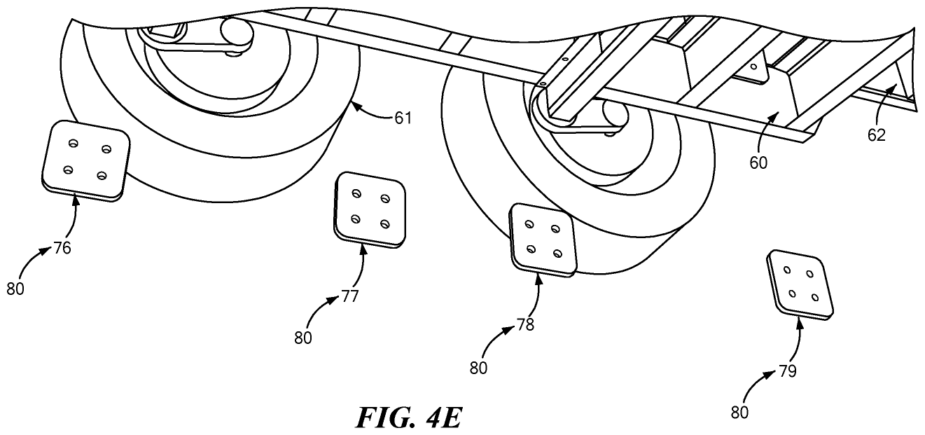

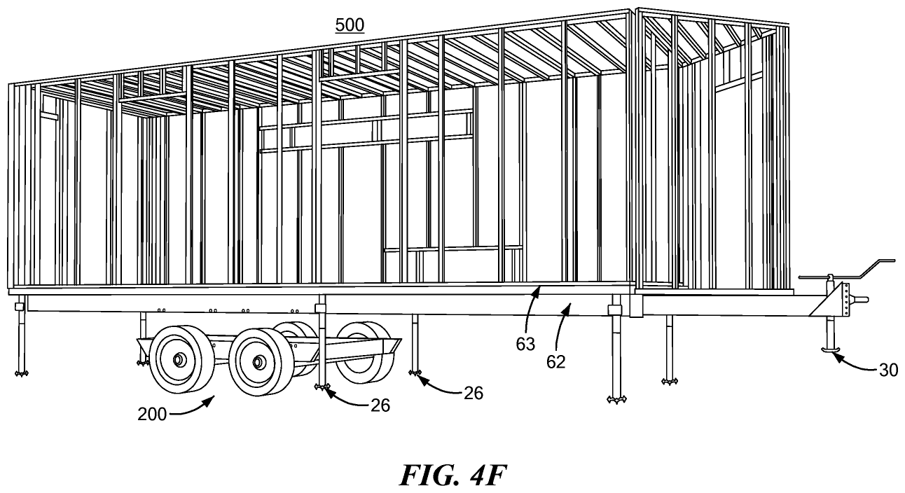

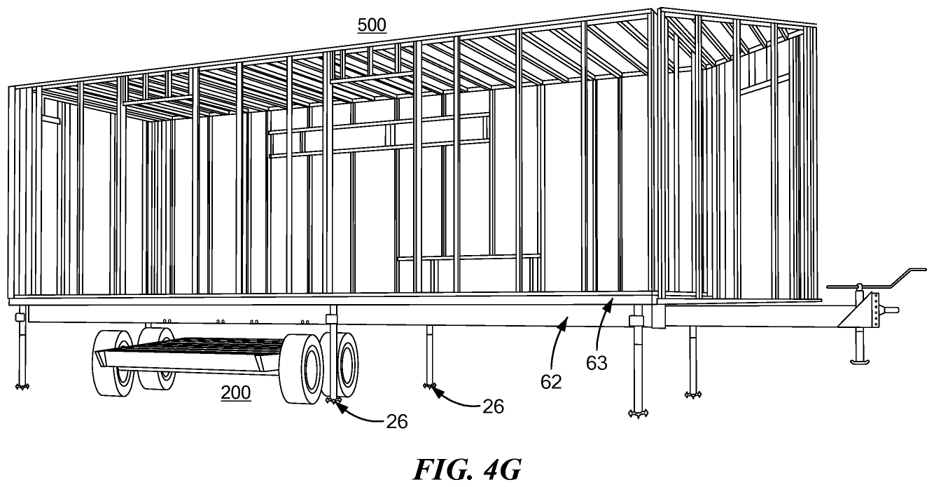

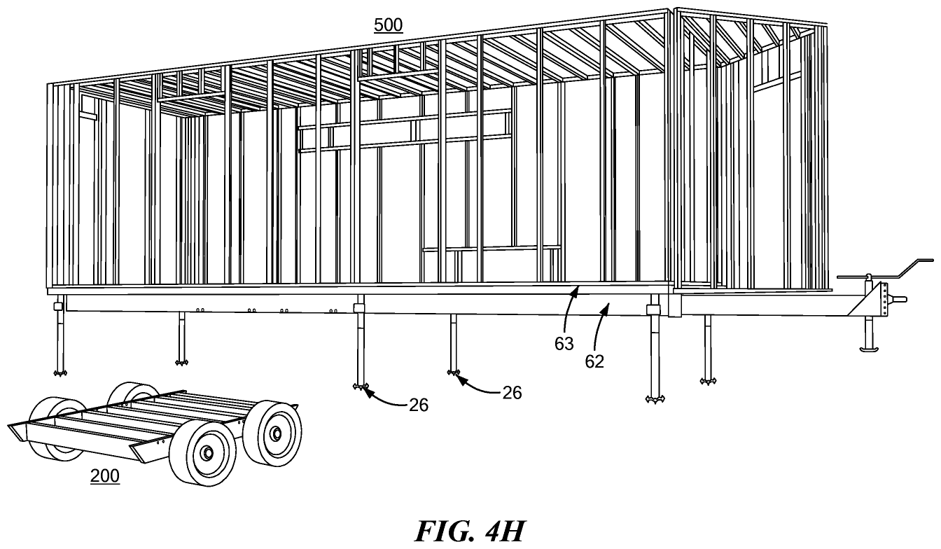

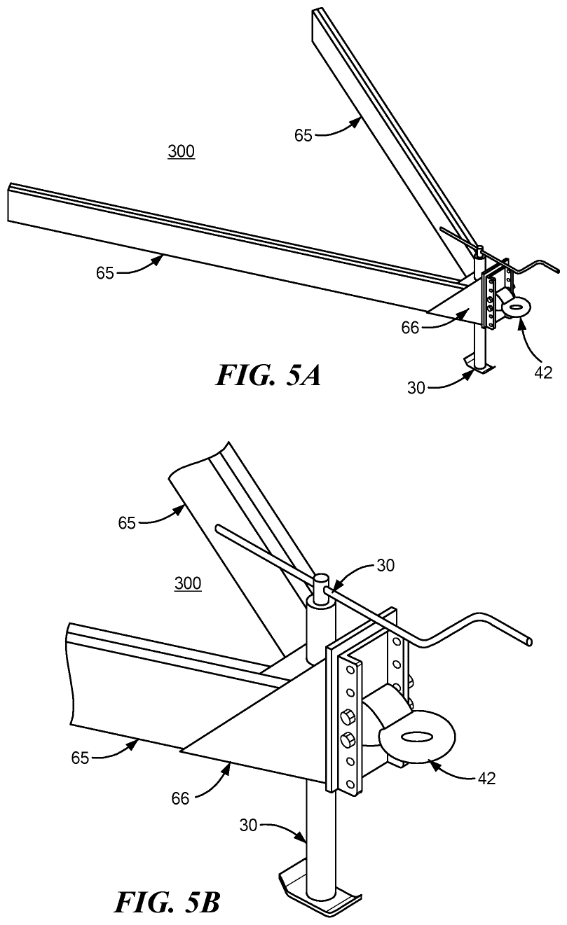

An example of removal of the removable axle assembly 200 from under the base frame 62, in accordance with various embodiments, is depicted in FIGS. 4A-4H. According to some embodiments, referring to the view of FIG. 4A, the lifting system 26 can be utilized to lift the mobile business unit. The lifting system can include a piston mechanism positioned at each corner of a frame of the mobile business unit. The lifting system 26 can be a manual or motorized mechanical system, a pneumatic system, or an automatic hydraulic leveling system, for example, a Bigfoot© automatic hydraulic leveling system (thebigfootleveler.com). An auto-leveling hydraulic leveling system can provide two-way hydraulic pistons or cylinders which can provide an automated lift for raising the mobile business unit and for removal or installation of items under the mobile business unit.

Referring to FIG. 4B, the lifting system 26 is depicted supporting the mobile business unit. The base frame 62 is attached to the removable axle assembly 200 with a fixture assembly 80. The fixture assembly 80 can include outer fastener plate 81 and outer fastener plate 83. After deployment to a location, the mobile business unit can be converted to a stationary business unit by utilizing the lifting system 26 to lift the mobile container with the base frame 62 from the removable axle assembly 200. According to an aspect of this disclosure, FIG. 4C depicts release of a fixture assembly 80 including a first outer fastener plate 81, a second outer fastener plate 82, a third outer fastener plate 83, and a fourth outer fastener plate 84. FIG. 4D depicts a fixture assembly 80 including a first inner fastener plate 76, a second inner fastener plate 77, a third inner fastener plate 78, and a fourth inner fastener plate. FIG. 4E depicts released first, second, third, and fourth inner fastener plates. The fixture assembly 80, which attaches the removable axle assembly 200 to the base frame 62, can be released by detaching a plurality of fastener plates utilizing mechanical fasteners, for example, nuts and bolts. The fixture assembly 80 can include, for example, electromagnetic fasteners, automated mechanical fasteners, hand fasteners, or fasteners removable with hand tools (e.g., pliers and a wrench), which can be released before or after lifting the mobile container. As depicted in FIG. 4F, the removable axle assembly 200 is released from the base frame 62 of the mobile business unit.

According to some embodiments, FIG. 4G depicts the removable axle assembly turned after it has been released from the base frame 62. The removable axle assembly can be removed without turning the removable axle assembly, for example, by rolling the removable axle assembly towards the back of the mobile business unit until the removable axle assembly is out from under the mobile business unit. The removable axle assembly 200 can be rolled out from under the mobile business unit in the example depicted in FIG. 4H.

While removal of the axle assembly can provide some benefits of a stationary business unit, removal of the axle assembly 200 is optional and depends on the business needs. Removal of the axle assembly 200 can, for example, provide a theft deterrent when the mobile business unit is parked in a location. The removable axle assembly can be repositioned underneath the mobile container and reattached to the base frame to convert a stationary business unit to a mobile business unit.

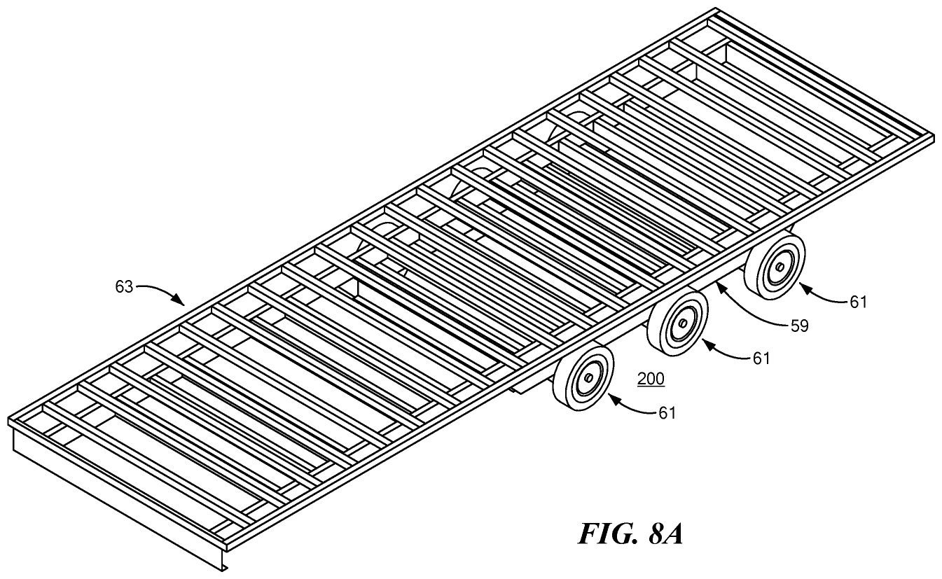

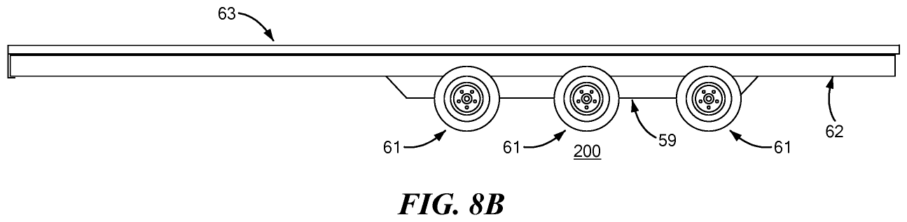

In some embodiments, the stationary business unit can also include a removable hitch assembly and optional removal of the towing hitch. An example removable hitch assembly 300, according to various embodiments, is depicted in FIG. 8A. The removable hitch assembly 300 includes a hitch frame 65 and a hitch connector 66. The hitch frame 65 can be removed from the base frame 62 depicted in FIG. 2B. An example of a tongue jack 30 attached to the hitch connector 66 at an apex of the hitch frame 65 is provided in FIG. 8A and in FIG. 8B. After deployment to a location, the towing hitch 42 and the tongue jack 30 can be removed from the hitch connector 66 using, for example, pliers and a wrench. In some configurations, the tongue jack 30 can be attached to and removed directly from the hitch frame 65. In another example, the tongue jack 30 is not required because a lifting system is operative to raise and to lower the towing hitch 42 for attachment to a vehicle. In some stationary business unit configurations, the hitch frame 65 can be removed, for example, to take up less space in the location, or to prevent passersby or vehicles from colliding with the hitch connector 66 or the hitch frame 65. The towing hitch 42 can be a pintle towing hitch or other suitable towing hitch. The tongue jack 30 can be a 10,000 pound (4536 kilogram) tongue jack or other suitable capacity tongue jack, depending on the size of the mobile business unit. For example, the tongue jack 30 can be a manually operated or turned tongue jack, a motorized tongue jack, an automated tongue jack, a self-leveling tongue jack, a remote controlled tongue jack, a hydraulic tongue jack, or a combination thereof.

According to some embodiments, a removable hitch assembly 300 can be removed to provide an exterior appearance of a stationary business unit. When removed, the removable hitch assembly can shorten the overall length of a mobile business unit. In some embodiments, the hitch frame 65 can provide an A-frame mechanism or tongue receiver at an apex of the hitch frame. The removable hitch frame can be removed to shorten the total exterior length of a business unit provided herein. The shortening, for example, can shorten the total exterior length of a business unit to fit within a few parking spaces, three parking spaces, two parking spaces, one parking space, or within a closed garage. In the examples depicted in FIGS. 8A and 8B, the removable hitch assembly 300 includes the towing hitch 42 attached to the hitch connector 66 and the tongue jack 30 attached to the hitch connector 66 at an apex of the hitch frame 65.

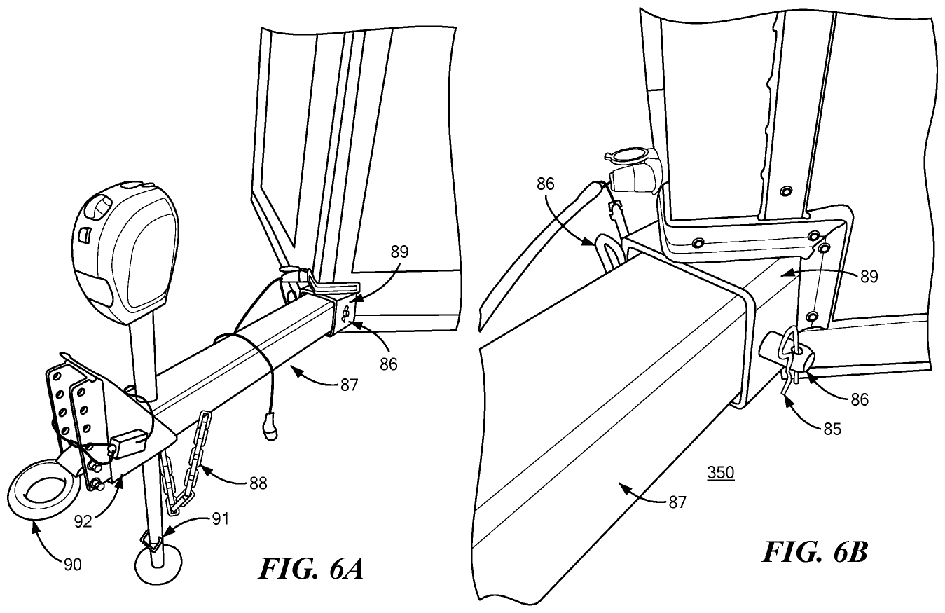

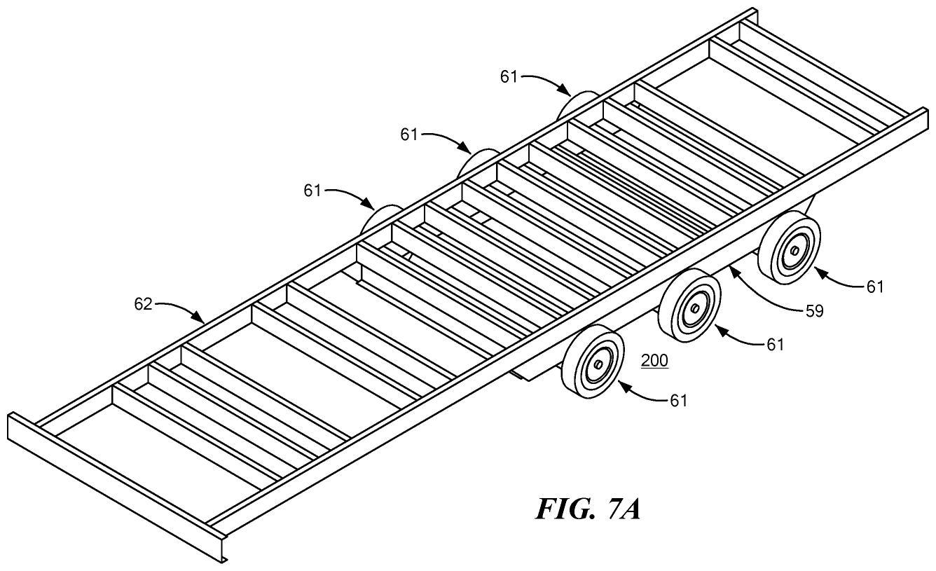

In some embodiments, a retractable hitch assembly 350 including a tongue 87 can be provided as shown in FIGS. 6A and 6B. A distal end of the tongue 87 can be secured in a tongue receiver 89. For example, as shown in FIG. 6B, a lock pin 86 can secure the tongue 87 in the tongue receiver 89. At a proximal end of the tongue 87, a hitch connector 92 can be provided with a towing hitch 90, a tongue jack 91, and safety chains 88. The hitch connector 92, the towing hitch 90, and the tongue jack 91 can be, for example, substantially similar to the hitch connector 66, towing hitch 42 and tongue jack 30 described above with reference to FIGS. 8A and 8B. The hitch connector 92, towing hitch 90, tongue jack 91, and safety chains 88 can be removed from the tongue 87, for example, by utilizing hand tools. The tongue 87 can be extended to a fully extended position during towing of a mobile business unit. The tongue 87 can be retracted by removing lock pin 86 and pushing the tongue 87 into the tongue receiver 89. Although described and shown herein as retractable into the receiver, it will be apparent in view of this disclosure that, in some embodiments, the tongue 87 of the retractable hitch assembly 350 can also be configured to be optionally extractable from the tongue receiver 89 for providing removable hitch functionality.

FIG. 6B depicts a perspective view of the tongue 87 and the tongue receiver 89. In some embodiments, a cotter pin 85 can secure a lock pin 86. The cotter pin 85 can be removed from the lock pin 86 and the lock pin 86 can be removed from the tongue receiver 89 and the tongue 87. After removal of the lock pin 86, the tongue 87 can be pushed towards the tongue receiver 89 until the tongue is flush with the tongue receiver.

According to some embodiments, the mobile business unit can be shortened by a function of a removable hitch assembly 300 or a retractable hitch assembly 350. The mobile business unit 100 illustrated in FIG. 1 can have, for example, exterior measurements from back to the front towing hitch of about 35 feet (10.67 meters) long by about 8.5 feet (2.59 meters) wide from side to side. Two standard parking spaces placed end to end can measure 36 feet (10.97 meters) long and 9 feet (2.74 meters wide). Two standard parking spaces positioned end to end can provide a location for this example. The mobile business unit is not limited by size and can be constructed for larger (e.g., three parking spaces) or smaller locations (e.g., one parking space). In general, a compact parking space is understood in the parking industry to be 8 feet (2.44 meters) wide and 16 feet (4.88 meters) long and a standard parking space is generally understood to be 9 feet (2.74 meters) wide and 18 feet (5.49 meters) long. However, it will be apparent in view of this disclosure that, depending on the physical shape of the parking facility, the location of the parking facility, the age of the parking facility, the company operating the parking facility, intended vehicle type, combinations thereof, or any other factors, parking spaces and mobile business units may be provided with any other suitable combination of dimensions. By removing the removable hitch assembly 300 or retracting the retractable hitch assembly 350, the mobile business unit can be shortened to fit in a desired space.

### Composite Impermeable Flooring Structure Having Integrated Baseboards

In another aspect of the invention, a composite impermeable flooring structure having integrated baseboards can be provided in an interior portion of the mobile business unit. The composite impermeable flooring structure having integrated baseboards can be configured for rapid washing or sterilization of the floor and baseboards. The integrated baseboards can provide a transition joint connecting an interior floor with the lower portion of an interior wall. For example, the transition joint can provide washing or sterilization of a portion of the interior wall, along with the baseboard and floor, without leakage. An exterior surface of the composite impermeable flooring structure having integrated baseboards can provide a non-slip surface for walking or standing. For example, the non-slip surface can be impermeable, water proof, grease and oil resistant, chemical resistant, heat resistant, fireproof, and wear resistant.

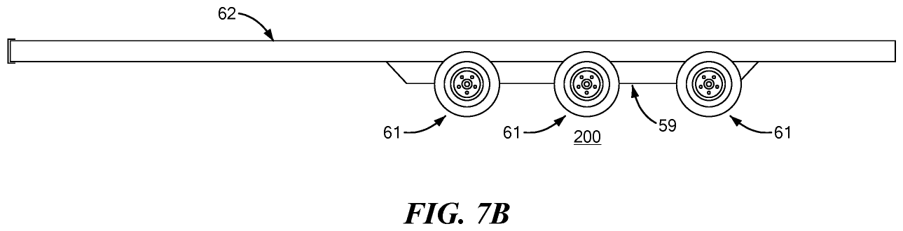

A composite impermeable flooring structure having integrated baseboards can be positioned above a main frame of the mobile business unit or above a floor on the main frame. The main frame 63 can be affixed to the base frame 62 as depicted in FIG. 2B. A base frame 62 depicted in FIG. 7A and in FIG. 7B is shown without the main frame affixed to the base frame. A main frame 63, according to an aspect of this disclosure, is depicted in FIG. 8A (perspective view) and in FIG. 8B (side view). The main frame 63 is positioned on top of the base frame 62 (FIG. 8B). The mainframe can be connected to the base frame 62 by, for example, permanent welds, adhesive, fasteners, or other means. The main frame 63 is affixed to the mobile container 400 (FIG. 1) of the mobile business unit. Referring to FIG. 4A, a mobile container frame 500 can be mounted along a circumference of the main frame 63, wherein an interior surface of the main frame and one or more interior surfaces of the container frame can define an interior volume of the mobile business unit.

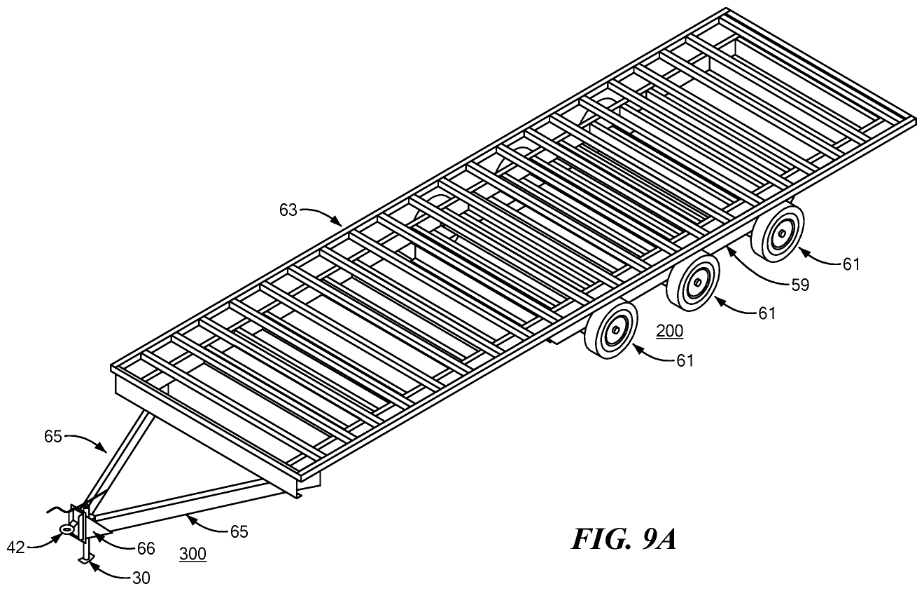

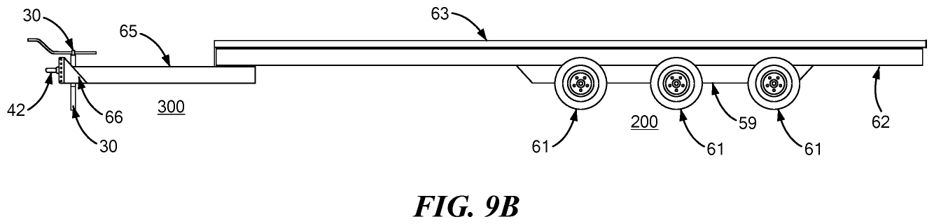

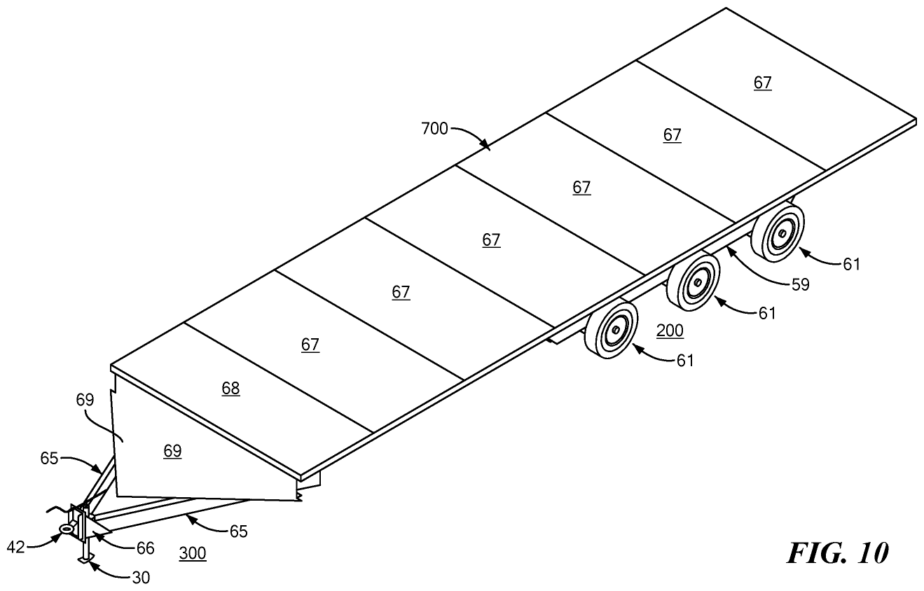

A floor can be affixed to the main frame 63, which is shown in FIG. 9A and FIG. 9B. According to some embodiments, referring now to FIG. 10, a floor 700 is affixed to the main frame 63, which is shown in FIG. 9A and FIG. 9B. In some embodiments, the floor 700 can include a plurality of floor panels 67 and one or more floor panels with a different size 68 or shape 69. In FIG. 10, a floor panel 68 with a different size is shown at the front of the main frame, and a floor panel 69 with a different shape is positioned partially covering the hitch frame 65. The floor 700 can be a stainless steel floor that can be provided in a plurality of stainless steel panels, or the floor can be provided as a single floor unit that is cut to the size and shape of a main frame 63. A composite impermeable flooring structure having integrated baseboards can be directly affixed to the main frame 63. A composite impermeable flooring structure having integrated baseboards can be integrated with the floor 700 or the plurality of floor panels depicted in FIG. 10 and positioned above the main frame 63 of FIG. 9B. A composite impermeable flooring structure having integrated baseboards can be positioned above the plurality of floor panels depicted in FIG. 10, for example, with one or more layers between the floor panels depicted in FIG. 10 and the composite impermeable flooring structure having integrated baseboards.

The floor 700 including, for example, floor panels 67, 68, and 69 depicted in FIG. 10 can be composite flooring panels including a foundation layer for contacting the interior surface of the main frame, a resilient or energy absorbent layer disposed over the foundation layer, and a support layer disposed over the resilient or energy absorbent layer. The foundation layer can include, for example, plywood, wood composite, plastic, metal, or a combination thereof. The foundation layer can be attached to the main frame, for example, by screwing, bolting, welding, or a combination thereof. Each composite flooring panel can include an interior layer, which may include a paint layer, an adhesive layer, or a combination thereof, interposed between the foundation layer and the resilient or energy absorbent layer. The composite flooring panels can be joined together by an adhesive, a weld, an impermeable coating, or a combination thereof. In some embodiments, the floor 700 can include a composite impermeable flooring structure.

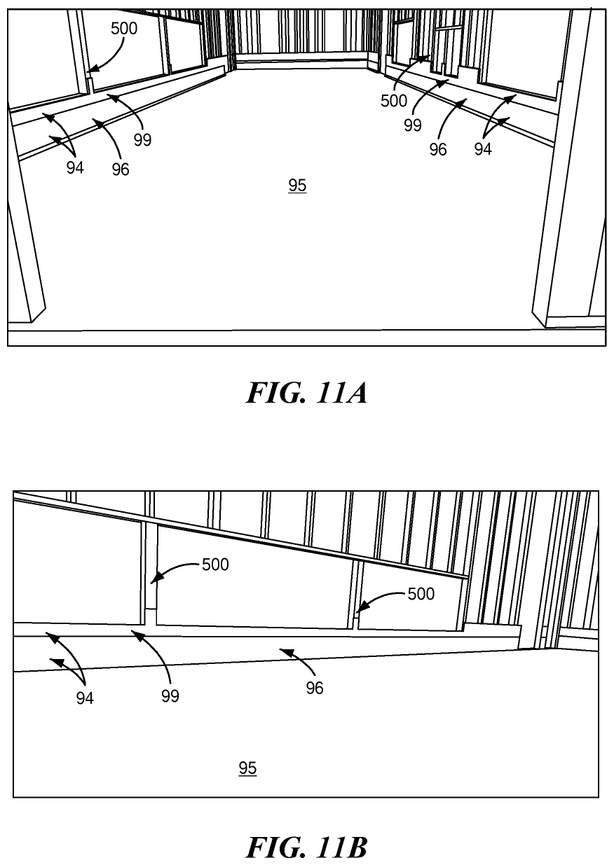

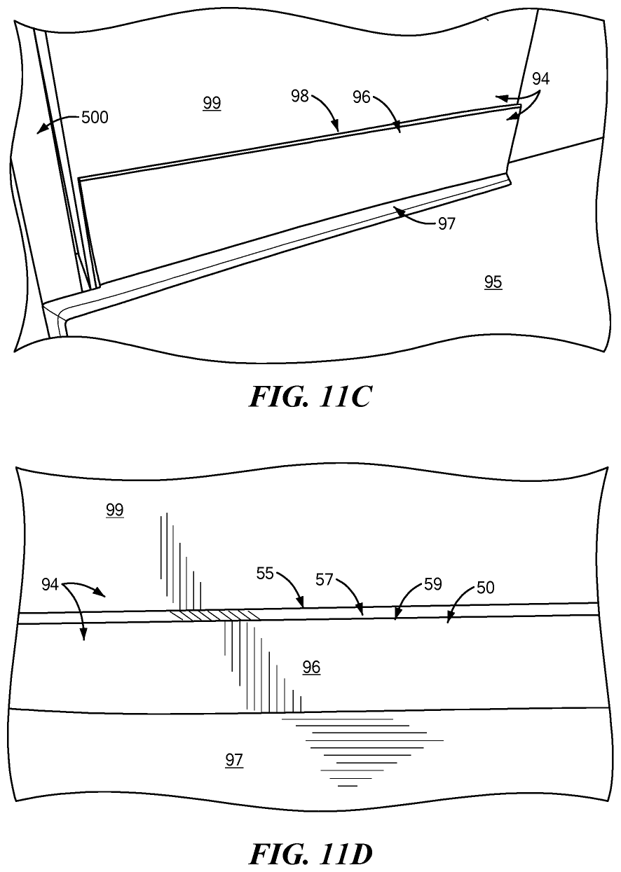

FIGS. 11A-11D illustrate a composite impermeable flooring structure 95 having composite baseboards 94 in accordance with various embodiments. Each composite baseboard 94 can include a wall layer 99 and one or more layers 96 disposed over the wall layer. The wall layer 99 can contact the interior of the mobile container frame 500 of the mobile business unit. The one or more layers 96, for example, can include an interior layer disposed over the wall layer 99, a resilient or energy absorbing layer, a support layer, an impermeable layer, or a combination thereof. An impermeable coating can extend over the composite impermeable flooring structure 95 and the composite baseboard 94 to form an interior surface of the composite impermeable flooring structure having integrated baseboards. The wall layer 99, for example, can include plywood, wood composite, metal or alloy, plastic, or a combination thereof.

As shown in the detail views of FIG. 11C-11D, in some embodiments a transition joint 97 can be provided between the composite baseboard 94 and the composite impermeable flooring structure 95. The transition joint can include, for example, a right angle, a fillet, a chamfer, or a combination thereof. The transition joint 97 can include the same materials, layers, or composites as the composite impermeable flooring structure 95. The transition joint may include a separate material, for example, a metal or an alloy weld, a polymer, a silicone, an epoxy, or a combination of materials. The transition joint 97 can include a chamfer between the composite baseboard 94 and the composite impermeable flooring structure 95. The chamfer can provide a bevel for a transitional edge between the composite baseboard 94 and the composite impermeable flooring structure 95. The transition joint 97 can include a fillet or a rounding curvature between the composite baseboard 94 and the composite impermeable flooring structure 95. The fillet can include a concave curvature. A concave curvature can form a tub-like surface including the transition joint 97, the composite baseboard 94, and the composite impermeable flooring structure 95. For example, a curvature at the transition joint 97 can allow for liquid to drain down the composite baseboard 94 and onto the composite impermeable flooring structure 95. The transition joint 97 can be configured for easy cleaning and sterilization of the interior of the mobile business unit. An edge 98 can be applied on a composite baseboard 94 with a wall layer 99 and one or more layers 96 disposed over the wall layer.

According to an aspect of this disclosure, FIG. 11D shows a photo of a composite baseboard 94 including a wall layer 99 and one or more layers 96 disposed over the wall layer. A paint and/or adhesive layer 55 can be disposed over the wall layer 99 to provide additional sealing and/or adhesion. A resilient or energy absorbing layer 57, an interior layer 59, and an impermeable layer 50 are depicted in FIG. 11D. The paint/adhesive layer 55 can be between the wall layer 99 and the resilient or energy absorbing layer 57. An interior layer 59 can be provided between the resilient or energy absorbing layer 57 and the impermeable layer 50. An edge 98, which is shown in FIG. 11C, can form a seal between a wall layer 99 and the one or more layers 96. For example, the seal can be water proof, grease and oil proof, chemical resistant, heat resistant, and wear resistant. The seal can form a bevel at the transition from the wall layer 99 and the one or more layers 96. For example, the seal can include the same material as the impermeable layer 50. In some embodiments, the seal can include an epoxy, a silicone, a flexible polymer, an adhesive, a filler, or a combination of materials that are applied after the one or more layers 96 is positioned on a wall layer 99.

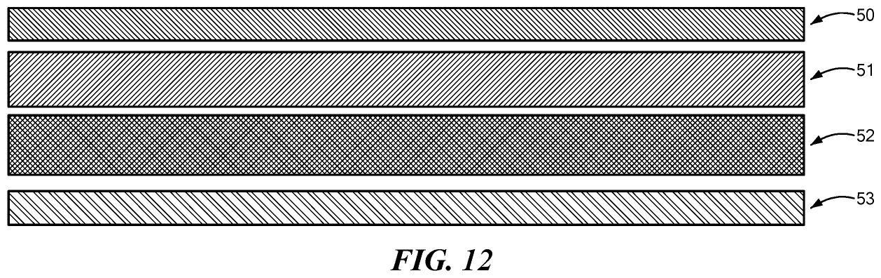

A composite impermeable flooring structure having integrated baseboards can include a floor material. The floor material can include one or more layers, for example, an impermeable layer, a resilient or energy absorbing layer, a support layer, a support layer, a paint/adhesive layer, or combinations thereof. In this way, the additional layers can be added for added chemical resistance, electrical resistance, heat or cold resistance, heavier loading requirements, or vibration dampening, for example. According to some embodiments, referring to FIG. 12, an example of a floor material diagram shows an impermeable layer 50 on top of a support layer 51. The support layer 51 can include metal or plastic or any other suitable rigid or semi-rigid impermeable material. The support layer 51 can be constructed from steel diamond plate. The impermeable layer 50 can include polyurea, polyurethane polyurea/polyurethane hybrids, rubber, an epoxy, Ultra High Molecular Weight Polyethylene (UHMW-PE), or combinations thereof. For example, the impermeable layer 50 can be a bed liner non slip coating. In some embodiments, a texture can be included with the impermeable layer 50 or directly underneath on the support layer 51 in order to promote additional non-slip functionality (e.g., where the impermeable layer is textured or impregnated with grit-forming particles or the support layer 51 is diamond plate).

Under the support layer 51 can be a resilient or energy absorbing layer 52. The resilient or energy absorbing layer 52 can be an open-cell foam, a closed-cell foam, a gel-infused foam, a gel pad, rubber, rubber foam, or combinations thereof. At bottom is a foundation layer 67 (shown in FIG. 10) for engagement with the main frame. The foundation layer 67 can include, for example, plywood, wood composite, plastic, or metal. In some embodiments, the composite floor can also include a paint and/or adhesive layer 53 interposed between the foundation layer 67 and the resilient or energy absorbing layer 52. In some embodiments the paint/adhesive layer can include, for example, latex paint, oil paint, epoxy, acrylates, acrylic latex, polyvinyl acetate, or combinations thereof.

It will be apparent in view of this disclosure that, in accordance with various embodiments, the wall layer 99 and other layers 96 of the composite baseboard material can, individually or as a whole, be similar to the layers 67, 53, 52, 51 of the composite floor material. Generally speaking, the impermeable layer 50 should be a single layer extending over the entire composite floor and the integrated baseboards.

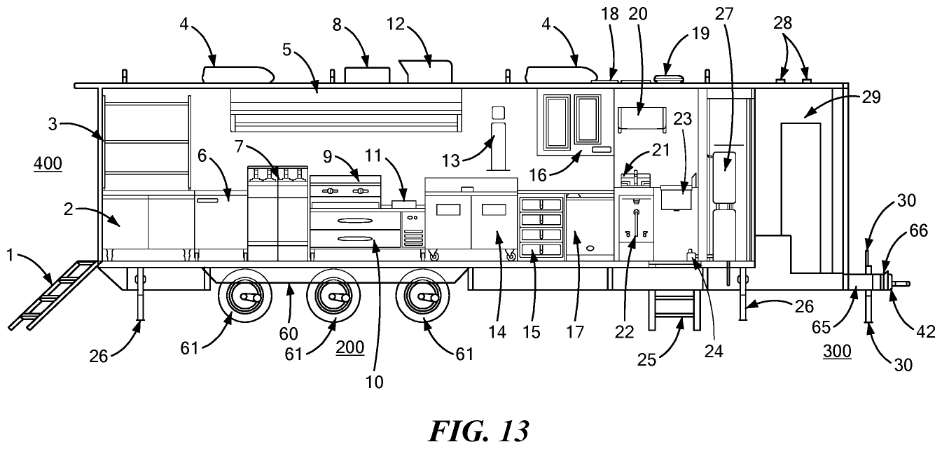

The floor material diagram shown in FIG. 12 can illustrate a component of a composite impermeable flooring structure for the exterior of the mobile business unit, for example, on the foldup staircase 1 and on the foldup staircase 25 depicted in FIG. 13. The composite impermeable flooring structure can be atop the floor, baseboards, and a portion of the sidewalls in the mobile business unit.

A non-slip surface can be at least on a portion of the composite impermeable flooring structure having integrated baseboards. In some embodiments, the non-slip surface can be any surface having a measure of slip resistance. For example, in some embodiments the non-slip surface can have a static coefficient of friction (SCOF) greater than 0.1 as measured when the surface is clean and dry. In general, SCOF defines the ratio between the force required to put an object in motion and the downward force exerted on it from gravity. A SCOF close to zero refers to slippery surfaces whereas a SCOF near 1 refers to high friction surfaces. In some embodiments, the SCOF of the non-slip surface can be, for example, greater than 0.5, greater than 0.6, or greater than 0.8.

Mobile Business Units as described and disclosed herein can be constructed and configured for use in connection with a wide array of mobile or rapidly deployable applications including, for example, kitchens, classroom or office space, medical facilities, insurance or disaster relief facilities, fabrication units, pharmacies, grocery-to-go units, broadcasting centers, or combinations thereof. In addition, regardless of configuration, in some applications two or more mobile business units can be positioned proximately to one another in side by side, perpendicular, or end to end, configurations to provide larger facilities to meet business needs. Furthermore, in some embodiments the mobile business can be configured to operate while in transport from one location to another. For example, a dishwasher may be able to continue operating while moving a mobile business unit configured for use as a kitchen from one location to another, thereby making clean pots, pans, dishes, silverware, etc. available immediately upon arrival at the new location.

### Example Ghost Kitchen Embodiment

One example application is that of a ghost kitchen. As noted above, ghost kitchens are remote off-premises kitchens that allow restaurants to outsource the making of their takeout and delivery meals, while enabling the preparation of the meals closer to the customer.

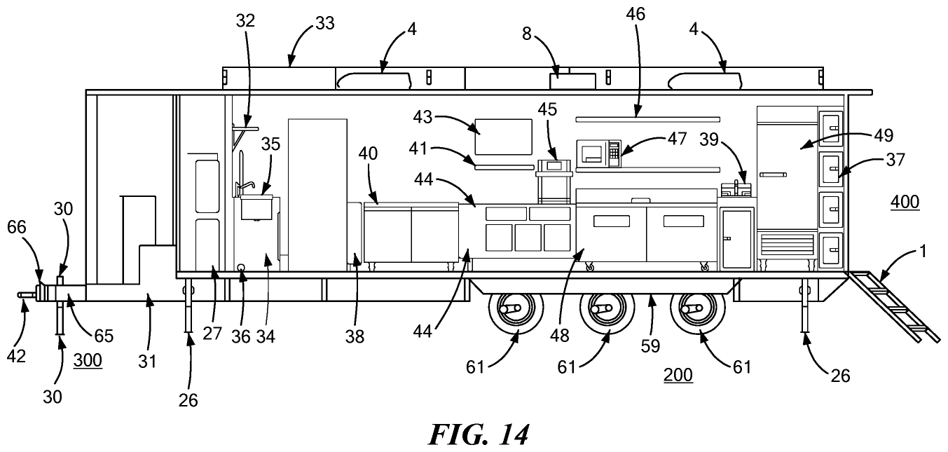

An example business unit configuration for a ghost kitchen or mobile kitchen, according to various embodiments, is depicted in FIGS. 13 and 14. As shown in FIG. 13, an interior of a first side (e.g., the driver side as shown) of a ghost kitchen can include various equipment. Such equipment can include, for example, an under-counter refrigerator freezer 2, a refrigerator 6, a dishwasher 17, a hand sink 21, a mop sink 22, a 3-compartment sink 23, a water pump 24, a fire suppression system 13, an electric fryer 7, an electric griddle 9, and an induction stove 11. In some embodiments, the interior of the business unit can include storage, table space, and shelving including a metro wire rack 3, a 60″ chef base 10, a 48″ prep table 14, equipment storage drawers 15, a metro smart wall and drying rack 20, and an above head storage cabinet 16. An extraction hood 5, can be configured, for example, above an induction stove 11. Ventilation features include A/C units with heat and condensation pump 4, a makeup air fan 8, an extraction fan 12, and a bathroom fan 19. The ventilation features can be affixed to an exterior side of the mobile business unit instead of to the roof, for example, to accommodate a low ceiling of an interior parking garage.

According to some embodiments, the equipment can distribute water from fresh water tanks 27, power from solar panels 18, data from GPS and LTE antennas 28 and from an IT box 29. In another example, the above head storage cabinet 16 can contain a low voltage inverter and voltage monitor to accept, monitor, transform, and provide current at different voltages.

As shown in FIG. 14, an interior of a second side (e.g., the passenger side as shown) of the ghost kitchen can have equipment installed in various locations, in accordance with some embodiments. Such equipment can include an IT box 31, roof mounted LED advertising screens 33, a water heater 34, a 3-compartment sink 35, a water pump 36, an under counter refrigerator 40, an order display monitor 43, a turbo chef oven 45, a microwave 47, a hand sink 39, an upright freezer 49, and delivery lockers 44. The interior of the business unit can include storage, table space, and shelving including a metro smart wall shelf 32, a 72″ preparation table 48, wall mount shelves 46, a trash bin 38, a wall mounted shelf 41, and employee lockers 37.

Still referring to FIG. 14, in some embodiments, the order display monitor 43 can be controlled by software and a microprocessor with RAM that is integrated with the delivery lockers 44 and that instructs chefs to place specific delivery orders into specific delivery lockers for each end customer. As shown in FIG. 14, the delivery lockers 44 can be connected to the delivery locker driver access door 70 (see FIG. 1), which can be a plurality of doors 70. Each delivery locker 44 can contain contents for a single end customer. Each delivery locker driver access door 70 can provide a delivery driver secured access to a product for a single delivery end customer. For example, a delivery driver can be directed to a specific delivery locker driver access door 70 by a software application on the delivery driver's smartphone or computer. The software application, for example, can unlock the specific delivery locker drive access door by a lock that is actuated by software. The software can be cloud software integrating orders, supplies, preparation, delivery, distance, and time, for example, that prioritizes preparation of orders for the chefs so that the most distant customers' orders are prioritized, taking into account traffic and distance. At any position on the mobile business unit, a customer service window or counter (not shown) can optionally be provided, for example, to provide direct contact with outdoor customers, delivery drivers, vendors, or employees.

Although the delivery lockers 44 are illustrated and described herein as being configured for placement of a single delivery order for a single end customer, it will be apparent in view of this disclosure that, in some embodiments, multiple discrete orders intended for multiple end customers can be aggregated into a single delivery locker 44. For example, such aggregation can be used where multiple orders are to be delivered by the same delivery driver in the same delivery run.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed is:

1. A mobile business unit comprising:
a mobile container having a base frame; and
an axle frame removably affixed to the base frame of the mobile container, the axle frame comprising:
a first longitudinal frame member extending substantially in a longitudinal direction of and along a first side of the base frame of the mobile container;
a second longitudinal frame member extending substantially in a longitudinal direction of and along a second side of the base frame of the mobile container;
a plurality of cross support frame members interconnected between the first and second longitudinal frame members;
a front axle assembly affixed to the axle frame proximate a front end of the axle frame, the front axle assembly including a first wheel proximate the first longitudinal frame member and second wheel proximate the second longitudinal frame member;
a back axle assembly affixed to the axle frame proximate a back end of the axle frame, the back axle assembly including a third wheel proximate the first longitudinal frame member and fourth wheel proximate the second longitudinal frame member; and
a fixture assembly configured to removably interconnect the axle frame to the base frame of the mobile container.

2. The mobile business unit of claim 1 wherein the mobile container is configured as one of a kitchen, an office, or a medical facility.

3. The mobile business unit of claim 1 further including a mid-axle assembly affixed to the axle frame proximate a middle of the axle frame, the mid-axle assembly including a fifth wheel proximate the first longitudinal frame member and sixth wheel proximate the second longitudinal frame member.

4. The mobile business unit of claim 1 wherein the mobile container includes a lifting system including a piston mechanism positioned at each corner of the base frame; wherein the piston mechanisms are configured to raise the mobile container to enable the removal of the axle frame and to lower the mobile container after removal of the axle frame.

5. The mobile business unit of claim 4 wherein the lifting system includes a self-leveling controller configured to adjust the piston mechanisms to level the mobile container.

6. The mobile business unit of claim 1 wherein the fixture assembly includes electromagnetic fasteners, automated mechanical fasteners, hand fasteners, mechanical fasteners, or a combination thereof.

7. The mobile business unit of claim 1 wherein the base frame includes a hitch frame assembly configured to allow the mobile business unit to be towed.

8. The mobile business unit of claim 7 wherein the hitch frame assembly includes a receiver to engage with a hitch on a tow vehicle to allow the mobile business unit to be towed.

9. The mobile business unit of claim 8 wherein the hitch frame assembly includes a removable hitch assembly wherein the removable hitch assembly can be removed from the mobile business unit.

10. The mobile business unit of claim 8 wherein the hitch frame assembly includes a retractable

11. A mobile business unit having a composite impermeable flooring structure having integrated baseboards comprising:
a main frame;
a container frame mounted along a circumference of the main frame, wherein an interior surface of the main frame and one or more interior surfaces of the container frame define an interior volume of the mobile business unit;
a plurality of composite flooring panels disposed on the interior surface of the main frame to form a composite floor, the composite flooring panels including:
a foundation layer for contacting the interior surface of the main frame,
a resilient, energy absorbing layer disposed over the foundation layer, and
a support layer disposed over the resilient or energy absorbent layer;
at least one composite baseboard extending along the main frame around at least a portion of the circumference of the composite floor, the composite baseboards including:
a wall layer for contacting the interior surface of the container frame, and
an interior layer disposed over the wall layer; and
an impermeable coating extending over the composite floor and the composite baseboard to form an interior surface of the composite impermeable flooring structure having integrated baseboards.

12. The mobile business unit of claim 11, wherein each composite panel also includes a paint layer, an adhesive layer, or a combination thereof interposed between the foundation layer and the resilient or energy absorbent layer.

13. The mobile business unit of claim 12, wherein the paint layer, adhesive layer, or combinations thereof include at least one of latex paint, oil paint, epoxy, acrylates, acrylic latex, polyvinyl acetate, or combinations thereof.

14. The mobile business unit of claim 11, wherein the foundation layer of each of the plurality of composite flooring panels is attached to the main frame by at least one of screwing, bolting, or welding.

15. The mobile business unit of claim 11, wherein the plurality of composite flooring panels are joined together by at least one of an adhesive, a weld, or the impermeable coating.

16. The mobile business unit of claim 11, wherein the plurality of composite flooring panels are joined to the at least one composite baseboard by at least one of an adhesive, a weld, or the impermeable coating.

17. The mobile business unit of claim 11, wherein the at least one composite baseboard includes a resilient, energy absorbing layer disposed between the wall layer and the interior layer of the baseboard.

18. The mobile business unit of claim 11, wherein, when coated by the impermeable coating, a transition joint between the integrated baseboard and the floor is at least one of a right angle, a fillet, or a chamfer.

19. The mobile business unit of claim 11, wherein each composite baseboard also includes at least one of a paint layer, an adhesive layer, or a combination thereof interposed between the wall layer and the interior layer.

20. The mobile business unit of claim 19, wherein the paint layer, adhesive layer, or combinations thereof include at least one of latex paint, oil paint, epoxy, acrylates, acrylic latex, polyvinyl acetate, or combinations thereof.

21. The mobile business unit of claim 11, wherein the foundation layer is constructed from at least one of plywood, wood composite, plastic, or metal.

22. The mobile business unit of claim 11, wherein the wall layer is constructed from at least one of plywood, wood composite, plastic, or metal.

23. The mobile business unit of claim 11, wherein the resilient, energy absorbing layer is constructed from an open-cell foam, a closed-cell foam, a gel-infused foam, a gel pad, rubber, rubber foam, or combinations thereof.

24. The mobile business unit of claim 11, wherein the support layer is constructed from at least one of plastic or metal.

25. The mobile business unit of claim 24, wherein the support layer is constructed from steel diamond plate.

26. The mobile business unit of claim 12, wherein the interior layer is constructed from at least one of plastic or metal.

27. The mobile business unit of claim 26, wherein the interior layer is constructed from steel diamond plate.

28. The mobile business unit of claim 11, wherein the impermeable layer is composed of at least one of polyurea, polyurethane polyurea/polyurethane hybrids, rubber, an epoxy, Ultra High Molecular Weight Polyethylene (UHMW-PE), or combinations thereof.
